(19) United States
(12) Patent Application Publication
(10) Pub. No.: US 2020/0260911 A1
(43) Pub. Date: Aug. 20, 2020

(54) Tiered Rack for Cooking Apparatus

(71) Applicant: Premier Specialty Brands LLC, Duluth, GA (US)

(72) Inventor: Robert A. Brennan, Duluth, GA (US)

(73) Assignee: Premier Specialty Brands LLC, Duluth, GA (US)

(21) Appl. No.: 16/790,912

(22) Filed: Feb. 14, 2020

Related U.S. Application Data
(60) Provisional application No. 62/806,924, filed on Feb. 18, 2019.

(51) Int. Cl. A47J 37/07; A47J 36/16

(52) U.S. Cl. CPC A47J 37/0786; A47J 2037/0795; A47J 36/16

(57) ABSTRACT

The present disclosure is directed to a tiered rack for use with a cooking apparatus. The tiered rack comprises a base and stands that support two or more tiers of cooking surfaces. The tiers allow for substituting out various cooking surfaces and using different types of cooking surfaces at the same time.

### CROSS-REFERENCE TO RELATED APPLICATIONS

This application titled “Tiered Rack For Cooking Apparatus” is a non-provisional application claiming the benefit to Provisional Application No. 62/806,924 filed Feb. 18, 2019 and titled “Tiered Grill Rack,” which is hereby incorporated by reference in its entirety as if set forth below.

### TECHNICAL FIELD

Embodiments of the present disclosure relate generally to cooking apparatuses and accessories for cooking apparatuses. The present disclosure relates more specifically to a tiered rack configured for insertion within a cooking apparatus. The tiered rack provides a versatile and efficient use of space within the cooking apparatus.

### BACKGROUND

Smoking and grilling are common methods for cooking food. Kamado grilling, while known since ancient times, has grown in popularity over the last decade with the emergence of barrel-shaped cookers that allow for smoking food in the comfort of one's backyard. With the emergence of home cookers, the availability of accessories to improve the grilling experience has grown significantly and become an area for increased innovation.

Traditional kamado grills are limited by the size of their cooking space and the number of racks available for cooking food. Typical kamado-style grills include a single rack that fits within the grill body on which food can be placed and subsequently cooled. While this rack may be removed, it is not adjustable with respect to the heat source, does not efficiently use the space within the grill, and does not allow for versatility with respect to the food cooked on the grill.

An object of the present disclosure is to address these deficiencies and others associated with cooking apparatuses and accessories therefor.

### SUMMARY

Embodiments of the present disclosure relate to a tiered rack for insertion within a cooking apparatus. In one embodiment, the tiered rack comprises a base and a plurality of stands vertically disposed about a perimeter of the base. Each of the plurality of stands of the tiered rack comprise two or more platforms configured to support a cooking surface when the cooking surface rests on top of the platforms.

In some embodiments, the base of the tiered rack comprises a top shelf and a bottom shelf. In some embodiments, the diameter of the bottom shelf is less than the diameter of the top shelf. In other embodiments, the bottom shelf is a heat deflector plate.

In some embodiments, the plurality of stands comprise a waist portion that is configured to interface with the top shelf of the base. In further embodiments, each of the plurality of stands comprises legs that extend downward from the waist and intersect to support the bottom shelf of the base.

In some embodiments, the one or more of the platforms of the stands comprise an upwardly-extending member configured to interface with the cooking surface.

In some embodiments, the cooking surface is a stainless-steel grate, a laser cut surface, soapstone, cast iron grate, a cast iron griddle, or a cast iron grate.

Another embodiment of the present disclosure comprises a tiered rack for insertion within a cooking apparatus. The cooking apparatus can generally comprise a cooking chamber and a firebox. In this embodiment, the tiered rack comprises a base including a top shelf and a bottom shelf. The base is configured to rest atop the firebox of the cooking apparatus. The tiered rack also comprises a plurality of stands vertically oriented about a perimeter of the base, each of the plurality of stands comprising a first platform and a second platform, the first platform positioned above the second platform. The tiered rack can also comprise a first and a second cooking surface, the first cooking surface configured to rest atop the first platform and the second cooking surface configured to rest atop the second platform, such that the first cooking surface is positioned above the second cooking surface.

Another embodiment of the present disclosure is a a tiered rack comprising a base comprising a top shelf concentrically aligned with the bottom shelf and two or more stands vertically oriented and disposed around a perimeter of the base, the two or more stands each comprising: (a) two or more platforms for receiving a cooking surface, the two or more platforms stacked heightwise along the stands; (b) a waist interfaced with the top shelf of the base; and (c) legs supporting the bottom shelf of the base.

### BRIEF DESCRIPTION OF THE DRAWINGS

FIG. 1 is a tiered rack, in accordance with an embodiment of the present disclosure.

FIG. 2A shows a tiered rack within a cooking apparatus, in accordance with an embodiment of the present disclosure.

FIG. 2B shows a tiered rack within a cooking apparatus and supporting a cooking surface, in accordance with an embodiment of the present disclosure.

FIG. 2C shows a tiered rack within a cooking apparatus, in accordance with an embodiment of the present disclosure.

FIG. 2D shows a tiered rack within a cooking apparatus and including different types of tiered cooking surfaces, in accordance with an embodiment of the present disclosure.

FIG. 2E shows a cut-away view of a cooking apparatus showing various tiered cooking surfaces within the cooking apparatus.

### DETAILED DESCRIPTION

Embodiments of the presently disclosed subject matter include a tiered rack, and more particularly, a tiered rack for a cooking apparatus (e.g., a kamado-style grill). The tiered rack allows for enhanced flexibility and versatility by allowing for cooking different foods at different temperatures at the same time and using different types of cooking surfaces. The tiered rack also allows for adjustability of the cooking surface to allow for positioning closer to or away from the heating source.

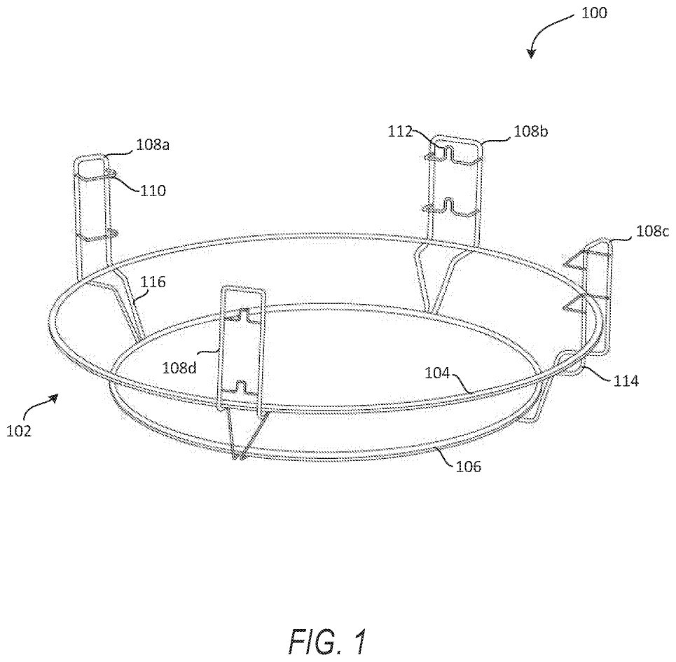

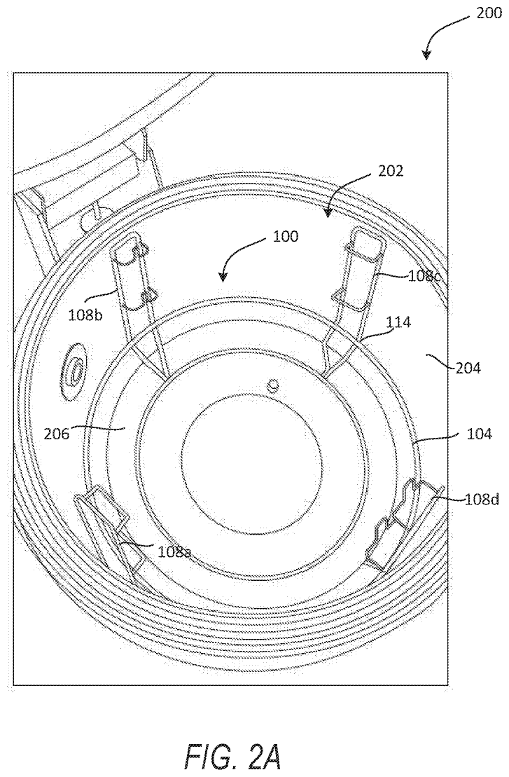

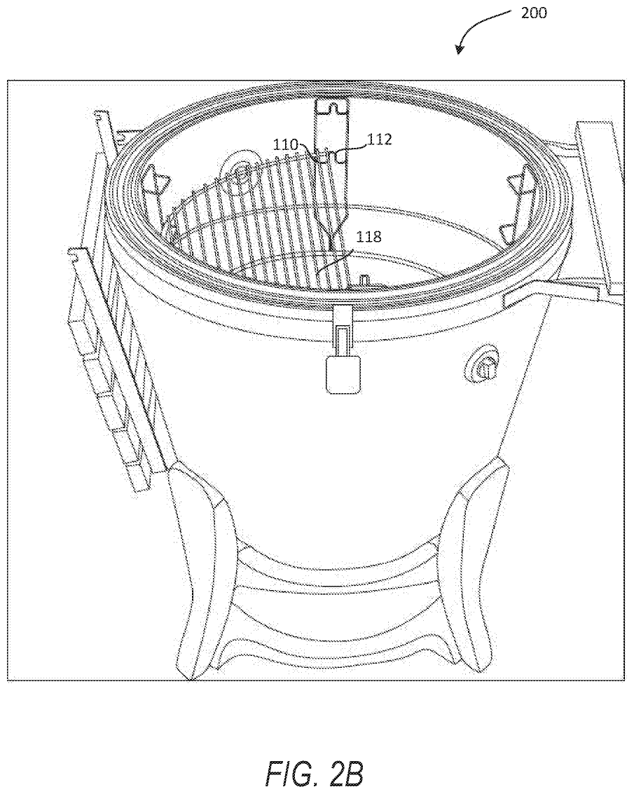

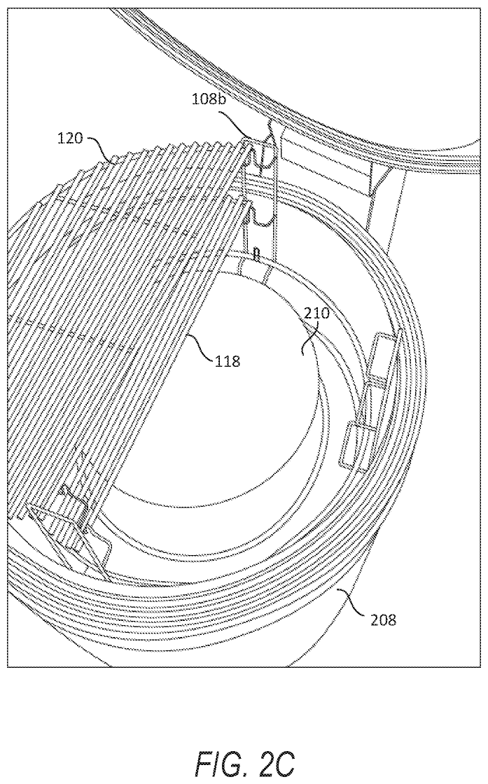

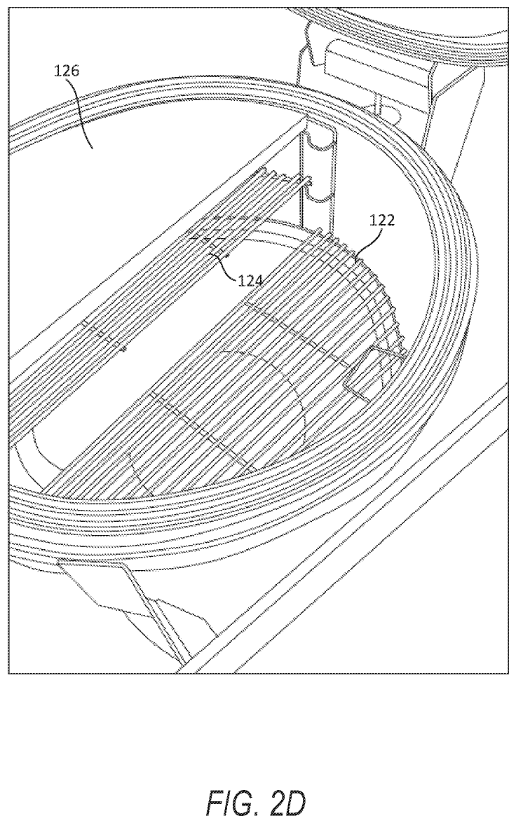

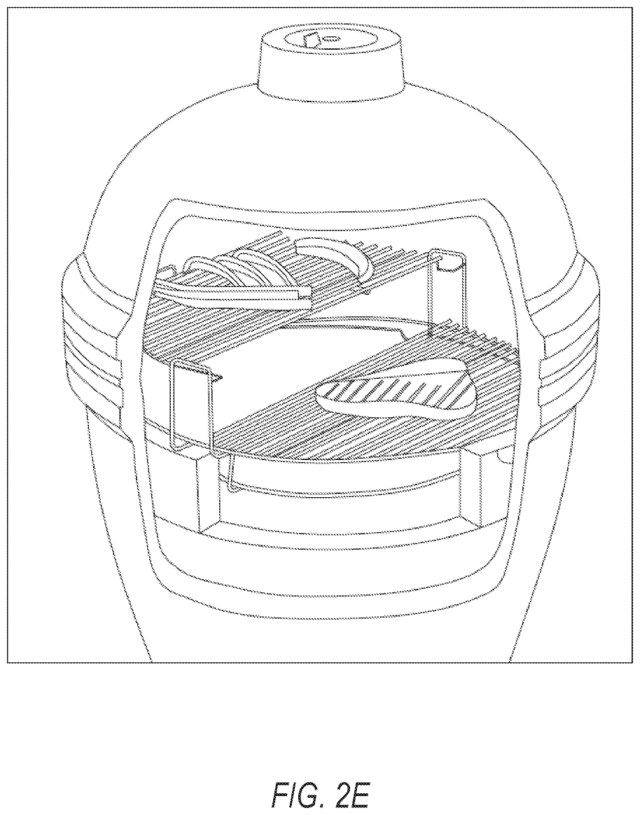

FIGS. 1-2E show an embodiment of a tired rack 100 and how it may be used with a cooking apparatus 200, in accordance with the present disclosure. FIGS. 1-2E are but one embodiment of the present disclosure and are not intended to be limiting on the entire scope of the claimed embodiments. Additionally, while the example embodiments are shown with respect to a kamado-style grill, it is understood that the rack can be used in other types of cooking apparatuses.

FIG. 1 shows an embodiment of a tiered rack 100 in accordance with the present disclosure. The tiered rack 100 generally comprises a base 102 and a plurality of stands 108a-d that are configured to support a plurality of cooking surfaces 118 (illustrated for instance in FIGS. 2A-2D). The plurality of stands 108a-d can be vertically oriented and disposed about the perimeter of the base 102. In other words, the plurality of stands 108a-d can be perpendicular to the base 102 and extend upward therefrom towards a top of the cooking apparatus.

The base 102 can comprise a top shelf 104 disposed above a bottom shelf 106. In some embodiments, the top shelf 104 and the bottom shelf 106 can be circular. For instance, the top shelf 104 and the bottom shelf 106 can be composed of circular wires. In some embodiments the top shelf 104 can have a diameter greater than the diameter of the bottom shelf 106. As illustrated in FIG. 1, the top shelf 104 and the bottom shelf 106 can be concentrically oriented. The top and bottom shelves 104, 106 can be held together by the plurality of stands 108a-d. In some embodiments, the bottom shelf 106 can comprise a heat deflection plate (not shown) configured to deflect heat away from the heating source.

The plurality of stands 108a-d can each comprise one or more platforms 110 that extend out from and perpendicular to the stands 108a-d. In some embodiments, the one or more platforms 110 can comprise an upward-extending structure 112. The upward-extending structure 112 can allow for dividing two or more cooking surfaces (illustrated in FIGS. 2B-2E) placed at the same tier. In embodiments in which the plurality of stands 108a-d have two or more platforms 110, the platforms 110 can be stacked height-wise along the stands 108a-d to permit for layering of two or more cooking surfaces 118. In some embodiments, the number of platforms 110 can correspond to the number of tiers that the tiered rack 100 comprises. For instance, in some embodiments, the tiered rack 100 can comprise stands 108a-d with two platforms 110 such that the tiered rack 100 can comprise two tiers. In other embodiments, the tiered rack 100 can comprise stands 108a-d with three platforms 110 such that the tiered rack 100 can comprise three tiers. Embodiments of the present disclosure contemplate any number of tiers.

The plurality of stands 108a-d can also comprise a waist 114 configured to rest on a top portion of the firebox 204 of the cooking apparatus 200. The plurality of stands 108a-d can also comprise legs 116 that support the bottom shelf 106 of the base 102.

The tiered rack 100 can have any number of stands 108a-d as necessary to support a cooking surface. In an example embodiment, as illustrated in FIG. 1, the tiered rack 100 can have four stands 108a-d. In some embodiments, the stands 108a-d can be disposed equidistant about the base 102.

In some embodiments, the tiered rack 100 can be composed of stainless-steel wire that is sufficiently resistant to exposure to high temperatures.

FIGS. 2A-2E show various configurations of the tiered rack 100 when disposed within a cooking apparatus 200 and more specifically a kamado-style grill.

FIG. 2A shows a tiered rack 100 disposed within a cooking apparatus 200 without any cooking surfaces. For reference, the cooking apparatus 200 can generally comprise a cooking chamber 202 defined by an interior wall 204 of the cooking apparatus 200 and a firebox 206 in which fuel is heated to increase the temperature within the cooking chamber 202 and cook food placed in the cooking chamber 202.

When the tiered rack 100 is disposed within the cooking chamber 202, the top shelf 104 of the base 102 and the waist 114 of the stands 108a-d can rest on a top portion of the firebox 206. The stands 108a-d can rest against the interior wall 204 of the cooking apparatus 200 or be placed proximate to the interior wall 204 of the cooking apparatus 200.

FIG. 2B shows a tiered rack 100 within the cooking apparatus 200, such as discussed with respect to FIG. 2A, but in this instance, the tiered rack 100 supports a cooking surface 118, specifically a grate, resting atop the platforms 110 of the stands 108a-b. The cooking surface 118 is semi-circular in shape and covers only a portion of the cooking chamber 202. The plurality of stands 108a-d can be configured to hold the cooking surface 118 substantially flat with respect to a heating element so that food can be cooked on the cooking surface 118. The upwardly extending structure 112 can allow for division between two different cooking surfaces 118 provided on the tiered rack 100.

While the cooking surface 118 of FIG. 2b is illustrated as a grate, it is understood that the cooking surface 118 may be any type of cooking surface now known or later discovered. For example, but not limitation, the cooking surface 118 can be at least one of a stainless-steel grate, a laser cut surface, soapstone, cast iron grate, a cast iron griddle, or a cast iron griddle grate.

In some embodiments, the tiered rack 100 can be in different positions within the cooking chamber 202 or be coupled with other types of accessories. FIG. 2C illustrates positioning of the tiered rack 100 such that the stands 108a-d can extend above the bottom portion 208 of the cooking apparatus. This configuration may be useful where the tiered rack 100 is used in conjunction with an insert 210 such as that described in WO2019140002 titled “Insert for Cooking Apparatus.” Additionally, FIG. 2C illustrates a first cooking surface 118 and a second cooking surface 120. The second cooking surface 120 is stacked above the first cooking surface 118.

When in use, the cooking surfaces 118 can be placed on the stands 108a-d in a tiered configuration, such as illustrated in FIGS. 2C or 2D. For instance, FIG. 2D illustrates a first tier holding a lower grate 122, a second tier holding an upper grate 124, and a third tier holding a pizza stone 126. This type of configuration can allow cooking at various levels as illustrated in FIG. 2E.

1. A tiered rack for insertion within a cooking apparatus, comprising:
a base; and
a plurality of stands vertically disposed about a perimeter of the base, each of the plurality of stands comprising two or more platforms configured to support a cooking surface when the cooking surface rests on top of the platforms.

2. The tiered rack of claim 1, wherein the base comprises a top shelf and a bottom shelf.

3. The tiered rack of claim 2, wherein the diameter of the bottom shelf is less than the diameter of the top shelf.

4. The tiered rack of claim 2, wherein the bottom shelf is a heat deflector plate.

5. The tiered rack of claim 2, wherein each of the plurality of stands comprises a waist portion configured to interface with the top shelf of the base.

6. The tiered rack of claim 5, wherein each of the plurality of stands comprises legs that extend downward from the waist and intersect to support the bottom shelf of the base.

7. The tiered rack of claim 1, wherein the one or more of the platforms of the stands comprise an upwardly-extending member configured to interface with the cooking surface.

8. The tiered rack of claim 1, wherein the cooking surface is a stainless steel grate, a laser cut surface, soapstone, cast iron grate, a cast iron griddle, or a cast iron grate.

9. A tiered rack for insertion within a cooking apparatus, the cooking apparatus comprising a cooking chamber and a firebox, the tiered rack comprising:
the base comprising a top shelf and a bottom shelf, the base configured to rest atop the firebox of the cooking apparatus;
a plurality of stands vertically oriented about a perimeter of the base, each of the plurality of stands comprising a first platform and a second platform, the first platform positioned above the second platform; and
a first and a second cooking surface, the first cooking surface configured to rest atop the first platform and the second cooking surface configured to rest atop the second platform, such that the first cooking surface is positioned above the second cooking surface.

10. The tiered rack of claim 9, wherein the diameter of the bottom shelf is less than the diameter of the top shelf.

11. The tiered rack of claim 9, wherein the bottom shelf is a heat deflector plate.

12. The tiered rack of claim 9, wherein each of the plurality of stands comprises a waist portion configured to interface with the top shelf of the base.

13. The tiered rack of claim 13, wherein the waist portion is further configured to interface with the firebox of the cooking apparatus.

14. The tiered rack of claim 13, wherein each of the plurality of stands comprises legs that extend downward from the waist and intersect to support the bottom shelf of the base.

15. The tiered rack of claim 9, wherein the one or more of the platforms of the stands comprise an upwardly-extending member configured to interface with the cooking surface.

16. The tiered rack of claim 9, wherein the first and second cooking surfaces are one of a stainless steel grate, a laser cut surface, soapstone, cast iron grate, a cast iron griddle, or a cast iron grate.

17. A tiered rack comprising:
a base comprising a top shelf concentrically aligned with the bottom shelf; and
two or more stands vertically oriented and disposed around a perimeter of the base, the two or more stands each comprising (a) two or more platforms for receiving a cooking surface, the two or more platforms stacked heightwise along the stands; (b) a waist interfaced with the top shelf of the base; and (c) legs supporting the bottom shelf of the base.

18. The tiered rack of claim 17, wherein the cooking surface is a stainless steel grate, a laser cut surface, soapstone, cast iron grate, a cast iron griddle, or a cast iron grate.

19. The tiered rack of claim 17, wherein the bottom shelf is a heat deflector plate.

20. The tiered rack of claim 17, wherein the two or more of the platforms of the stands comprise an upwardly-extending member configured to interface with the cooking surface.
